(19) United States
(12) Patent Application Publication
(10) Pub. No.: US 2017/0322862 A1
(43) Pub. Date: Nov. 9, 2017

(54) INFORMATION PROCESSING APPARATUS, METHOD, AND MEDIUM

(71) Applicant: PFU LIMITED, Kahoku-shi (JP)

(72) Inventors: Seigo Terada, Kahoku-shi (JP); Takashi Kobayashi, Kahoku-shi (JP)

(73) Assignee: PFU LIMITED, Kahoku-shi (JP)

(21) Appl. No.: 15/662,570

(22) Filed: Jul. 28, 2017

Related U.S. Application Data
(63) Continuation of application No. PCT/JP2015/062105, filed on Apr. 21, 2015.

(51) Int. Cl. G06F 11/34; H04L 29/06; H04L 12/26; H04L 29/08; H04L 12/24; G06F 11/30

(52) U.S. Cl. CPC G06F 11/3485; H04L 67/1034; H04L 63/1408; H04L 43/062; H04L 43/06; H04L 43/0882; H04L 41/0668; G06F 11/30; H04L 43/026; H04L 43/10

(57) ABSTRACT

In order to control communication in an IPv6 environment, a network monitoring apparatus includes a communication data acquisition unit that acquires communication data in a network, a target terminal determination unit that determines whether a terminal included in a source or a destination of the acquired communication data is a target terminal meeting a predetermined condition, and a communication guiding unit that, by notifying the target terminal of a physical address of a predetermined terminal as a physical address of a terminal other than the target terminal, guides the communication data sent from the target terminal, to the predetermined terminal.

### CROSS-REFERENCE TO RELATED APPLICATION

This application is a continuation application of International Application PCT/JP2015/062105 filed on Apr. 21, 2015, and designated the U.S., the entire contents of which are incorporated herein by reference.

### FIELD

This disclosure relates to technology of controlling communication in a network.

### BACKGROUND

Hitherto, there has been proposed an unauthorized access preventing apparatus which, when receiving a neighbor solicitation message of a duplicate address detection sent from an unregistered terminal, replies to the effect that the address is duplicated, and when receiving a neighbor solicitation message, which is sent from a violation terminal and of which target is neither a patch server nor a policy manager, blocks the unauthorized terminal from communicating in a network and permits the patch server and the policy manager to communicate with the violation terminal by replying to the source of the received neighbor solicitation message to the effect that a link layer address for the target is changed to a fake address (see Japanese Patent Application Publication No. 2011-217016).

### SUMMARY

According to an example of this disclosure, there is provided an information processing apparatus, including: communication data acquisition means for acquiring communication data in a network; target terminal determination means for determining whether a terminal included in a source or a destination of the acquired communication data is a target terminal meeting a predetermined condition; and communication guiding means for, by notifying the target terminal of a physical address of a predetermined terminal as a physical address of a terminal other than the target terminal, guiding communication data sent from the target terminal, to the predetermined terminal.

This disclosure can be understood as an information processing apparatus, a system, a method performed by a computer, or a program executed by a computer.

This disclosure can be understood as the program as above recorded in a recording medium readable by a computer, other apparatuses, other devices, and the like.

Here, “the recording medium readable by the computer and the like” means a recording medium capable of accumulating information such as data or programs through electrical, magnetic, optical, mechanical, or chemical action, and readable by the computer and the like.

### BRIEF DESCRIPTION OF THE DRAWINGS

FIG. 1 is a schematic diagram illustrating a configuration of a system according to an embodiment;

FIG. 2 is a diagram illustrating a hardware configuration of a network monitoring apparatus according to the embodiment;

FIG. 3 is a diagram illustrating the outline a function configuration of the network monitoring apparatus according to the embodiment;

FIG. 4 is a flowchart illustrating a flow of terminal management processing according to the embodiment;

FIG. 5 is a flowchart illustrating a flow of communication analyzing processing according to the embodiment;

FIG. 6 is a flowchart illustrating a flow of communication guiding processing according to the embodiment;

FIG. 7 is a flowchart illustrating a flow of transfer packet generating processing according to the embodiment;

FIG. 8 is a flowchart illustrating a flow of restore packet generating processing according to the embodiment; and

FIG. 9 is a schematic diagram illustrating a variation of a configuration of the system.

### DESCRIPTION OF EMBODIMENTS

An embodiment of a system 1 including an information processing apparatus according to this disclosure is described below with reference to the drawings.

In this embodiment, an example of guiding communication in a system managed using a management server is described, but the technology according to this disclosure can also be used to, guide, monitor, or restrict communication in a system in which a configuration different from the system exemplified in this embodiment is employed.

<Configuration of System>

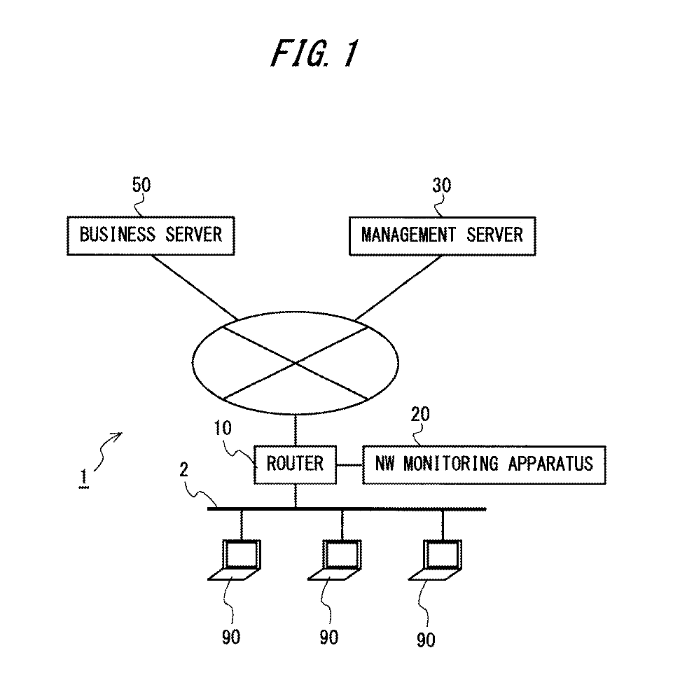

FIG. 1 is a schematic diagram illustrating a configuration of the system 1 according to this embodiment. The system 1 according to this embodiment includes a network segment 2 to which one or a plurality of user terminals 90 to be managed are connected, a business server 50 and a management server 30 connected to the user terminals 90 in the network segment 2 via a router 10 so as to be capable of communicating with each other, and a network monitoring apparatus 20 connected to a monitoring port of the router 10.

The business server 50 provides a service for business to the user terminal 90. The management server 30 serves as a network use application Web server, a patch distribution server, a quarantine server, and the like. For example, the management server 30 determines, for the user terminal 90 connected to the network segment 2, whether the user terminal SO is a “normal” terminal or an “abnormal” terminal based on the existence of a manager approval of the use application and the quarantine result, to thereby manage permission/disapproval of communication of the user terminal 90 in the network segment 2.

In the system 1 according to this embodiment, each type of server connected from the user terminal 90 is connected at a remote location via the internet or the wide area network, but those servers do not necessarily need to fee connected at a remote location. For example, those servers can be connected, to each other in a local network in which the user terminal 90 and the network monitoring apparatus 20 exist.

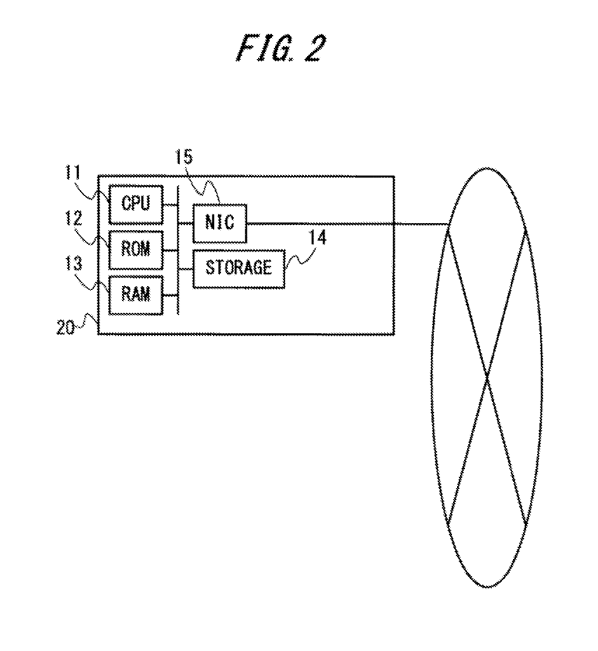

FIG. 2 is a diagram illustrating a hardware configuration of the network monitoring apparatus 20 according to this embodiment. The network monitoring apparatus 20 is a computer including a central processing unit (CPU) 11, a random access memory (RAM) 13, a read only memory (ROM) 12, a storage 14 such as an electrically erasable and programmable read only memory (EEPROM), a hard disk drive (HDD), and the like, a communication unit (network interface card) 15, and the like. However, omission, replacement, and addition can be made in the specific hardware configuration of the network monitoring apparatus 20 as appropriate depending on the embodiment. The network monitoring apparatus 20 is not limited to a single apparatus. The network monitoring apparatus 20 can be realized by a plurality of apparatuses with use of the technology of a so-called cloud or distributed computing and the like.

In FIG. 2, configurations other than the network monitoring apparatus 20 (the router 10, the management server 30, the business server 50, the user terminal 90, and the like) are not shown, but the router 10, the management server 30, the user terminal 90, the business server 50, and the like are all computers having hardware configurations similar to that of the network monitoring apparatus 20.

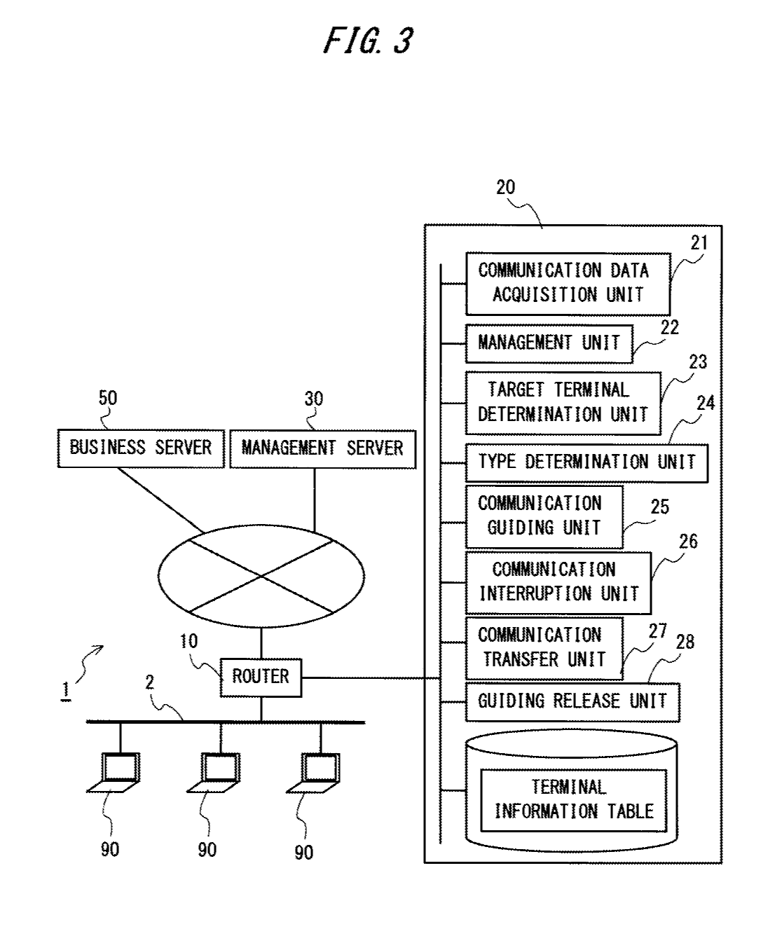

FIG. 3 is a diagram illustrating the outline of a function configuration of the network monitoring apparatus 20 according to this embodiment. When a program recorded in the storage 14 is read by the RAM 13 and executed by the CPU 11, the network monitoring apparatus 20 functions as an information processing apparatus including a communication data acquisition unit 21, a management unit 22, a target terminal determination unit 23, a type determination unit 24, a communication guiding unit 25, a communication interruption unit 26, a communication transfer unit 27, and an guiding release unit 28. In this embodiment, the functions of the information processing apparatus are executed by the CPU 11, which is a general-purpose processor, but a part of all of those functions can be executed by one or a plurality of special-purpose processors.

The communication data acquisition unit 21 acquires communication data in the network. As described above, the network monitoring apparatus 20 is connected to the monitoring port of the router 10 and acquires packets outputted to the monitoring port, to thereby acquire packets (communication data) sent and received by the user terminals 90.

The management unit 22 manages terminal information of the terminals in the network such as the user terminal 90, the router 10, the business server 50, the management server 30, and the like. Specifically, the management unit 22 accumulates and manages a MAC address (physical address) of the terminal connected to the network and an IPv6 address (logical address) corresponding thereto in a terminal information table in the storage 14 based on information input by the manager of the network and information acquired by analyzing the communication data acquired by the communication data acquisition unit 21. The management unit 22 accumulates and manages a terminal status, guiding information, transfer packet information, and the like in the terminal information table.

The terminal status is information indicating the status (normal/abnormal) of each terminal determined by the management server 30, and is saved in association with the terminal information of each terminal. As described above, in this embodiment, the management server 30 serves as the network use application Web server, the patch distribution server, the quarantine server, and the like. Thus, for example, the management server 30 notifies the network monitoring apparatus 20 to set the terminal status of “abnormal” for the terminal unapproved by the manager, the terminal that has not passed the quarantine, the terminal in which communication assumed to be due to malware is detected, and the like. The management server 30 notifies the network monitoring apparatus 20 to set the terminal status of “normal” for the terminal approved by the manager and the terminal that has passed the quarantine. The management unit 22 of the network monitoring apparatus 20 that has received the notification from the management server 30 saves the notified terminal status in the terminal information table in association with the terminal information of the corresponding terminal.

The guiding information is information in which the type and correct address information of a sent guiding packet is recorded in association with tho terminal information of each terminal that is notified of the guiding packet. The guiding packet is a packet that has provided notification of a false address information, and the correct address information is a combination of an IPv6 address and a correct MAC address corresponding to the IPv6 address. The types of the guiding packets are described later in the description of the flow of the processing.

The transfer packet information is information including the condition for the acquired packet to be transferred, and the transfer destination address of the packet to be transferred. In this embodiment, “the acquired packet is a Hypertext Transfer Protocol (HTTP) packet” is set as the transfer condition, for example. An IPv6 address of the management server 30 is set in the transfer destination of the HTTP packet, for example.

The target terminal determination unit 23 determines whether the terminal included in the source or the destination of the communication data is the target terminal meeting the predetermined condition by comparing the source or the destination of the acquired communication data and the terminal information managed by the management unit 22 as a target of communication guiding. In this embodiment, “the terminal information managed as a target of communication guiding” is the information on the terminal having the terminal status of “abnormal” set in the terminal information table.

The type determination unit 24 determines the type of communication data. The type determination unit 24 analyzes the header and the body of the communication data (packet) to determine, the protocol type, the message type, the multicast/unicast type, and the like of the communication data.

The communication guiding unit 25 notifies the target terminal of the MAC address of a predetermined terminal as the MAC address of a terminal other than the target terminal, to thereby handle a neighbor cache of the target terminal to guide the communication data sent from the target terminal, to the predetermined terminal. Further, the communication guiding unit 25 notifies the terminal other than the target terminal of the MAC address of the predetermined terminal as the MAC address of the target terminal, to thereby handle a neighbor cache of each notified terminal to guide the communication data of which destination to be sent is the target terminal to the predetermined terminal.

In this embodiment, the communication guiding unit 25 provides notification of the MAC address of the network monitoring apparatus 20 as the MAC address of the predetermined terminal, to thereby guide the communication data to the network monitoring apparatus 20. However, the MAC address notified as the MAC address of the predetermined terminal is not limited to the example in this embodiment. The communication guiding unit 25 can provide notification of the MAC address of a terminal that is to acquire the guided communication data, as the MAC address of the predetermined terminal.

In this embodiment, the communication to be guided is the IPv6 communication and a Neighbor Discovery Protocol (NDP) of an Internet Control Message Protocol for IPv6 (ICMPv6) is used for the guiding. Specifically, in this embodiment, the type of packet used in the guiding of the communication is a “neighbor advertisement (NA) message” or a “router advertisement (RA) message” used in the NDP of the ICMPv6.

In order to prevent the MAC address notified from the correct communication counterpart to be held in an access list of the terminal to be guided, the communication guiding unit 25 may notify the terminal of the MAC address for guiding a plurality of times at time intervals. When the notification is provided a plurality of times, the number of times of the notification and the time intervals are preferred to be configured as appropriate depending on the embodiment.

The communication interruption unit 26 interrupts at least a part of the communication with the target terminal by not transferring, to a proper destination, at least a part of the communication data acquired by the network monitoring apparatus 20 as a result of the guiding by the communication guiding unit 25.

When the type determination unit 24 determines that the communication data sent from the target terminal and acquired by the network monitoring apparatus 20 as a result of the guiding by the communication guiding unit 25 is a type of communication data that may be transferred to a predetermined destination, the communication transfer unit 27 transfers the communication data to the predetermined destination (for example, the management server 30).

When the terminal once determined by the target terminal determination unit 23 to be the target terminal does not meet the predetermined condition anymore, the guiding release unit 28 releases the guiding of the communication performed by the communication guiding unit 25, by notifying the correct MAC address to each terminal of which communication has been guided through the notification of the false MAC address. Specifically, the guiding release unit 28 notifies a terminal other than the target terminal of the correct MAC address of the target terminal, and notifies the target terminal of the MAC address of the terminal other than the target terminal, to thereby release the guiding of the communication performed by the communication guiding unit 25.

<Flow of Processing>

Next, the flow of the processing executed by the network monitoring apparatus 20 according to this embodiment is described with use of a flowchart. The specific content and order of the processing described below are an example of embodying the technology according to this disclosure. The specific processing details and processing order can be selected as appropriate depending on the embodiment of the technology according to this disclosure.

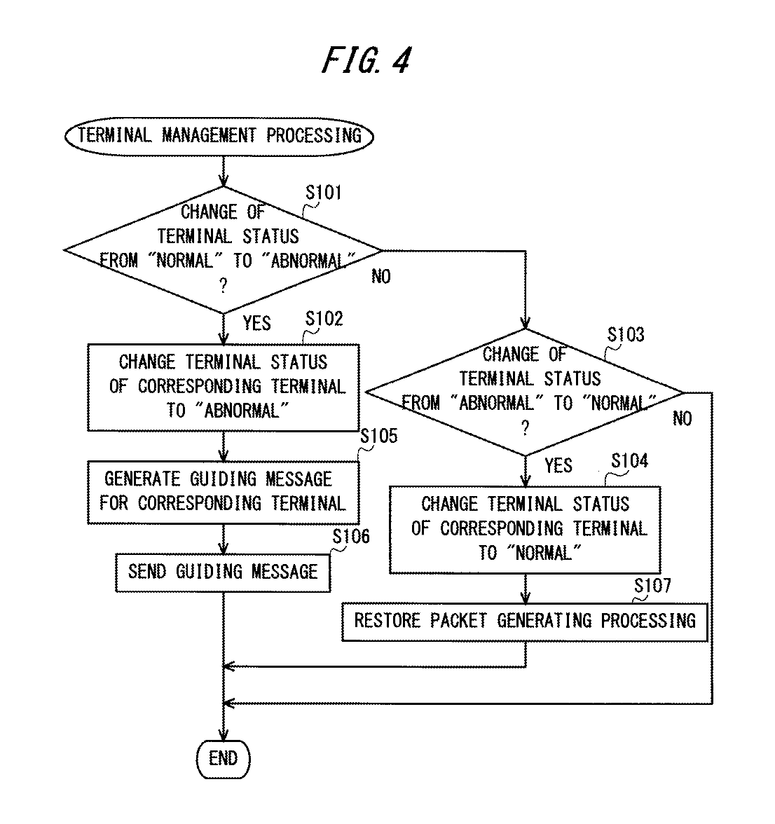

FIG. 4 is a flowchart illustrating a flow of a terminal management processing according to this embodiment. The terminal management processing according to this embodiment starts when a notification sent by the management server 30 to change the terminal status is received. The notification of the terminal status change includes information allowing the determination of the terminal to be changed (for example, the MAC address or the IPv6 address) and the content of the change.

In Step S101 to Step S104, the content of the change included in the received notification is determined and the terminal status is changed. When the content of the change is a change of the terminal status from “normal” to “abnormal” (YES in Step S101), the management unit 22 retrieves the information on the terminal to be changed from the terminal information table based on the information allowing the terminal designated by the received notification to be determined (for example, the MAC address or the IPv6 address), and configures the terminal status associated with the terminal information to “abnormal” (Step S102). Then, the processing proceeds to Step S105.

When the content of the change is a change of the terminal status from “abnormal” to “normal” (YES in Step S103), the management unit 22 retrieves the information on the terminal to be changed from the terminal information table based on the information allowing the terminal designated by the received notification to be determined, and configures the terminal status of the terminal to “normal” (Step S104). Then, the processing proceeds to Step S107.

In Step S105 and Step S106, the communication guiding packet is generated and sent. When the status of the terminal is changed from “normal” to “abnormal”, the communication guiding unit 25 generates a neighbor advertisement (NA) message for guiding or a router advertisement (RA) message for guiding relating to a default router and sends the generated message to the corresponding terminal.

Specifically, the communication guiding unit 25 generates a neighbor advertisement (NA) message in which the MAC address of the network monitoring apparatus 20 itself, a router flag (R flag), a reachable flag (S flag), and an overwrite flag (O flag) are set (Step S105) and sends the message from the communication unit 15 to the terminal of which terminal status is to be changed (terminal to be guided) (Step S106). Alternatively, the communication guiding unit 25 generates a router advertisement (RA) message advertising the MAC address of the network monitoring apparatus 20 itself as the MAC address corresponding to the IPv6 address of the router in a link local (Step S105) and sends the message from the communication unit 15 to the terminal to be guided (Step S106). When the message for guiding as above is sent, the neighbor cache of the terminal to be guided is controlled and the IPv6 communication of the terminal to be guided is guided to the network monitoring apparatus 20. Then, the processing illustrated in this flowchart ends.

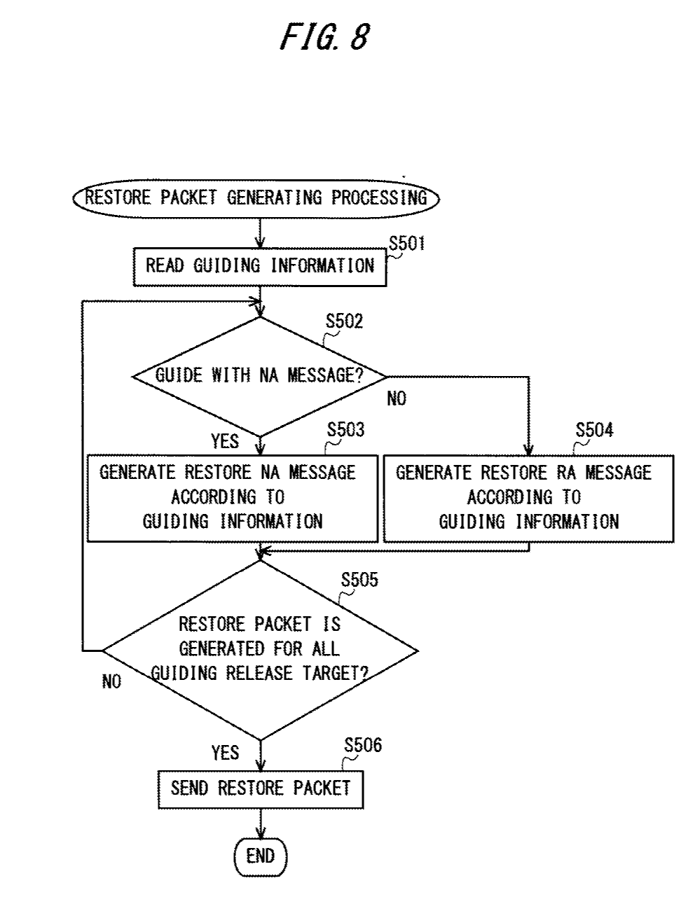

In Step S107, restore packet generating processing is executed. When the status of the terminal is changed from “abnormal” to “normal”, the guiding release unit 28 executes the restore packet generating processing in order to notify the neighbor cache of the relating terminal of the correct MAC address (restore the neighbor cache) and to end the guiding of the communication. The specific processing details of the restore packet generating processing are described later with reference to a flowchart in FIG. 8. Then, the processing illustrated in this flowchart ends.

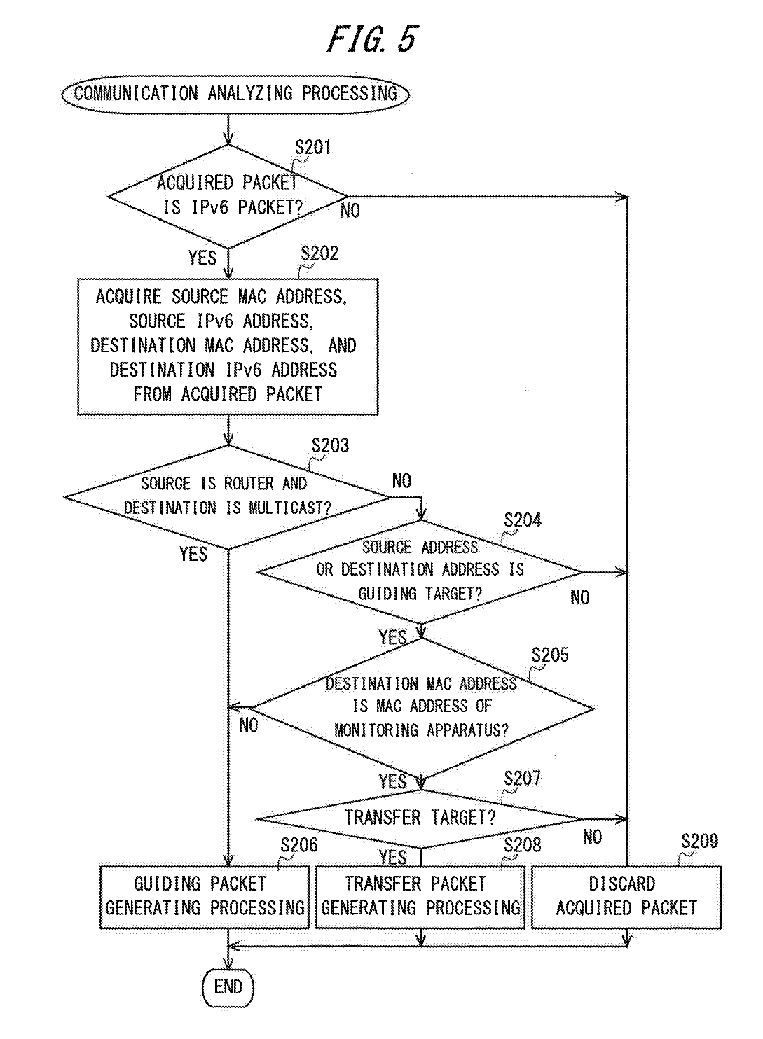

FIG. 5 is a flowchart illustrating a flow of communication analyzing processing according to this embodiment. The communication analyzing processing according to this embodiment starts when a packet is acquired by the network monitoring apparatus 20.

In Step S201, it is determined whether the acquired packet is an IPv6 packet. The communication data acquisition unit 21 refers to the header and the like of the packet acquired by the network monitoring apparatus 20, to thereby determines whether the packet is an IPv6 packet. The communication control according to this embodiment is a communication control targeting the IPv6 communication. Thus, when it is determined that the acquired packet is not an IPv6 packet, the processing proceeds to Step S209 and the packet is discarded. However, even when the acquired packet is not an IPv6 packet (for example, when the acquired packet is an IPv4 packet), the processing may proceed to processing for the corresponding protocol (description omitted) and processing such as communication analysis and communication guiding can be performed. When it is determined that the acquired packet is an IPv6 packet, the processing proceeds to Step S202.

In Step S202 to Step S204, information is extracted from the acquired packet and it is determined whether the terminal involved in the communication is a terminal that is the target of the communication guiding processing based on the extracted information. The target terminal determination unit 23 acquires a source MAC address and a source IPv6 address as source terminal information and acquires a destination MAC address and a destination IPv6 address as destination terminal information from the acquired packet (Step S202). Then, based on the information extracted in Step S202, the target terminal determination unit 23 determines whether the terminal included in the source or the destination of the acquired packet is a target terminal meeting the predetermined condition (Step S203 and Step S204).

When the source terminal is the router 10 and the destination is designated to be a multicast destination (YES in Step S203), the processing proceeds to guiding packet generating processing of Step S206. This is because there is a possibility that the terminal to be guided is included in the multicast destination.

When the determination result of Step S203 is NO (that is, when the destination is a unicast packet or when the source is a multicast packet that is not the router), the target terminal determination unit 23 compares the source address and the destination address extracted in Step S202 and the terminal information that is accumulated in the terminal information table in advance, to thereby determine whether the terminal related to the source or the destination of the packet is a terminal that is the target of the communication guiding processing (a terminal having “abnormal” set as the terminal status) (Step S204). When neither of the source terminal nor the destination terminal is the target of guiding as a result of checking the terminal status, the processing proceeds to Step S209 and the acquired packet is discarded. When it is determined that a terminal status of at least one terminal related to the source and the destination of the packet is “abnormal” and that the terminal is the terminal that is the target of the communication guiding processing as a result of checking the terminal status, the processing proceeds to Step S205.

In Step S205, it is determined whether the destination MAC address is the MAC address of the network monitoring apparatus 20. In order to determine whether the acquired packet is a packet of which communication is already guided, the network monitoring apparatus 20 determines whether the destination MAC address set in the acquired packet is the MAC address of the network monitoring apparatus 20. When it is determined that the destination MAC address is the MAC address of the network monitoring apparatus 20, the packet is a packet for which the guiding of the communication has already succeeded. Hence, the processing proceeds to Step S207. When it is determined that the destination MAC address is not the MAC address of the network monitoring apparatus 20, the packet is a packet of which communication is not guided. Hence, the processing proceeds to the guiding packet generating processing of Step S206.

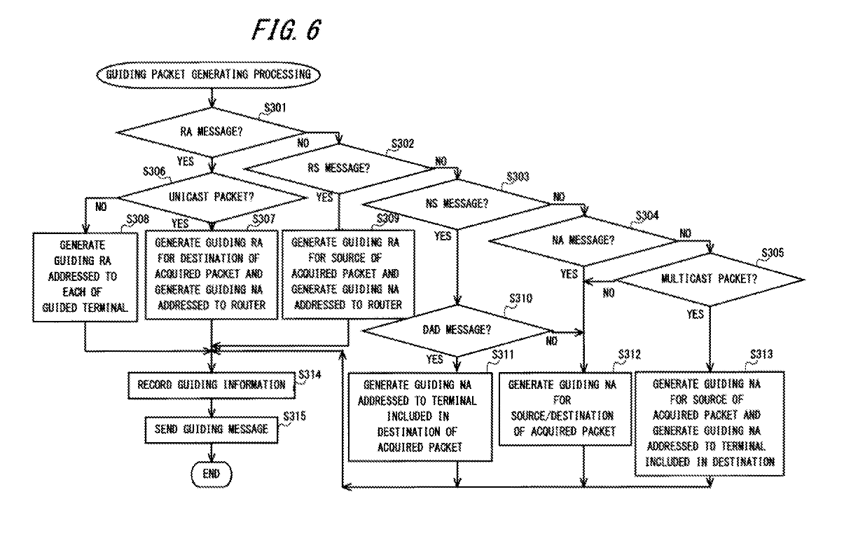

In Step S206, the guiding packet generating processing is performed. The specific processing details of the guiding packet generating processing are described later with reference to a flowchart in FIG. 6.

In Step S207 and Step S208, transfer packet generating processing is executed when the acquired packet is a packet to be transferred. The type determination unit 24 analyzes the header or the body of the acquired packet determined in Step S205 to have succeeded in communication guiding based on the transfer packet information configured in advance in the terminal information table, and determines whether the acquired packet is a packet to be transferred, to thereby determine the transfer destination (Step S207). When it is determined that the acquired packet is a packet to be transferred, the transfer packet generating processing is executed (Step S208). When it is determined that the acquired packet is not a packet to be transferred, the processing proceeds to Step S209.

As described above, in this embodiment, “the acquired packet is an HTTP packet” is set as the transfer condition, for example, and the MAC address and the IPv6 address of the management server 30 are set as the transfer destination, for example. As a result, in Step S207, for example, when the acquired packet is an HTTP packet, it is determined that the acquired packet is a packet to be transferred and the MAC address and the IPv6 address of the management server 30 are determined as the transfer destination of the acquired packet.

In this way, an HTTP access from the terminal for which the terminal status of “abnormal” is set because the terminal is not approved by the manager can be redirected to the management server 30. When the management server 30 receives the redirected HTTP access, the management server 30 sends a Web page for the network use application and the like to the source terminal of the acquired packet (unapproved terminal), for example. The unapproved terminal sends the network use application to the management server 30 via the Web page. Then, when the network use application is approved by the manager, the management server 30 sends a notification to change the terminal status to “normal” to the network monitoring apparatus 20. The processing performed by the network monitoring apparatus 20 that has received the notification is already described with use of FIG. 4. The management server 30 that has received the redirected packet may perform distribution of the patch or quarantine for the terminal for which the terminal status of “abnormal” is set.

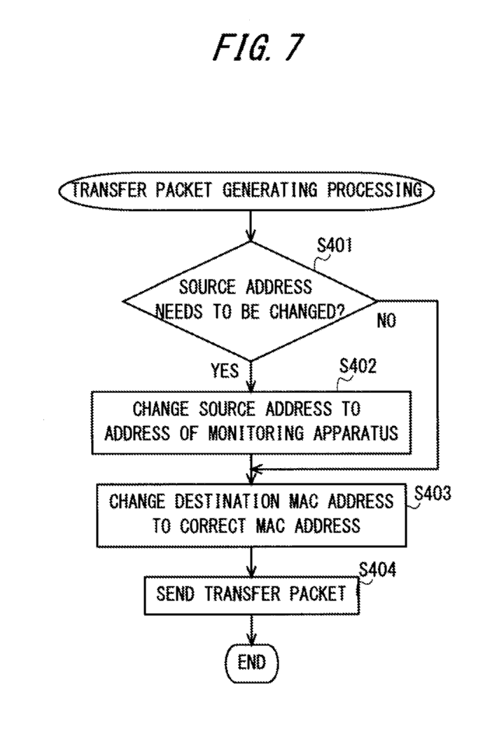

Specifically, according to the technology of this embodiment, the load on the operation and management of the network can be reduced by interrupting unnecessary communication due to a disapproved terminal and transferring the IPv6 packet of the guided corresponding terminal to the management server 30 serving as the network use application Web server, the patch distribution server, the quarantine server, and the like. The specific processing details of the transfer packet generating processing are described later with reference to a flowchart in FIG. 7.

In Step S209, the acquired packet is discarded. The communication interruption unit 26 does not transfer the acquired packet to the proper destination and discards the packet. That is, in the system according to this embodiment, the communication in the network with the terminal to be guided is interrupted by guiding the packet related to the target terminal to the network monitoring apparatus 20 and not transferring (discarding) the guiding packet. Then, the processing illustrated in this flowchart ends.

FIG. 6 is a flowchart illustrating a flow of communication guiding processing according to this embodiment. This flowchart illustrates the communication guiding processing of Step S206 in FIG. 5 in more detail.

In Step S301 to Step S304, it is determined whether the acquired packet corresponds to a predetermined message used in the NDP of the ICMPv6. The type determination unit 24 refers to the header of the acquired packet to determine which of a router solicitation (RS) message, a router advertisement (RA) message, a neighbor solicitation (NS) message, and a neighbor advertisement (NA) message used in the NDP the acquired packet corresponds to.

The router solicitation (RS) message is a type of communication data for inquiring router information including the MAC address of the router in the network, the router advertisement (RA) message is a type of communication data for providing notification of router information including the MAC address of the router by the unicast/multicast, the neighbor solicitation (NS) message a type of communication data for inquiring the MAC address corresponding to the IPv6 address of the terminal in the network, and the neighbor advertisement (NA) message is a type of communication data for notifying the router of the MAC address corresponding to the IPv6 address of the terminal in the network.

When it is determined that the acquired packet is a packet including the router advertisement (RA) message, the processing proceeds to Step S306. When it is determined that the acquired packet is a packet including the router solicitation (RS) message, the processing proceeds to Step S309. When it is determined that the acquired packet is a packet including the neighbor solicitation (NS) message, the processing proceeds to Step S310. When it is determined that the acquired packet is a packet including the neighbor advertisement (NA) message, the processing proceeds to Step S312. When it is determined that the acquired packet is none of the types of the packets described above, the processing proceeds to Step S305.

In Step S305, it is determined whether the acquired packet is a unicast packet. The type determination unit 24 determines whether the acquired packet determined in Step S301 to Step S304 described above to be none of the router solicitation (RS) message, the router advertisement (RA) message, the neighbor solicitation (NS) message, and the neighbor advertisement (NA) message of the NDP is a unicast packet related to other types of communication (for example, the TCP/UDP communication or a Ping of the ICMPv6). The determination is performed by referring to the protocol number, the destination IPv6 address, and the like set in the header. When it is determined that the acquired packet is a unicast packet, the processing proceeds to Step S312. When it is determined that the acquired packet is a multicast packet, the processing proceeds to Step S313.

In Step S306 to Step S308, the guiding packet generating processing performed when it is determined that the acquired packet is a router advertisement (RA) message is executed. When the acquired packet is a router advertisement (RA) message, the type determination unit 24 determines whether the destination IPv6 address is a unicast address (Step S306).

When the destination address is a unicast address (YES in Step S306), the communication guiding unit 25 generates a neighbor advertisement (NA) message for guiding for notifying the router 10 of the MAC address of the network monitoring apparatus 20 as the destination MAC address of the terminal, and generates, for the destination terminal of the packet, a router advertisement (RA) message for guiding for notifying the destination terminal of the packet of the MAC address of the network monitoring apparatus 20 as the MAC address of the router 10 (Step S307). Then, the processing proceeds to Step S314.

When the destination address is a multicast address (NO in Step S306), the communication guiding unit 25 acquires the router information from the router advertisement (RA) message of the acquired packet, and generates, for each of one or a plurality of terminals included in the multicast destination, a unicast router advertisement (RA) message for guiding (Step S308) for notifying the terminal of the MAC address of the network monitoring apparatus 20 as the MAC address of the router 10. Then, the processing proceeds to Step S314.

In Step S309, the guiding packet generating processing performed when it is determined that the acquired packet is a router solicitation (RS) message is executed. When the type determination unit 24 determines that the packet is a router solicitation message, the communication guiding unit 25 generates, for the source terminal of the packet, a router advertisement (RA) message for guiding for notifying the source terminal of the packet of the MAC address of the network monitoring apparatus 20 as the MAC address of the router 10, and generates, for the destination router of the packet, a neighbor advertisement (NA) message for guiding for notifying the destination router of the packet of the MAC address of the network monitoring apparatus 20 as the MAC address of the source terminal. Then, the processing proceeds to Step S314.

In Step S310 to Step S311, the guiding packet generating processing performed when it is determined that the acquired packet is a duplicate address detection by the neighbor solicitation (NS) message is executed. When the destination IPv6 address and the source IPv6 address set in the neighbor solicitation (NS) message are identical (NO in Step S310, that is, when the acquired packet is a duplicate address detection), the communication guiding unit 25 generates, for each terminal receiving the acquired packet, a neighbor advertisement (NA) message for guiding for notifying the terminal of the MAC address of the network monitoring apparatus 20 as the MAC address corresponding to the source IPv6 address (Step S311). The duplicate address detection is a neighbor solicitation (NS) message for inquiring the MAC address of the terminal having the IPv6 address of the terminal itself (that, is, the user terminal 90 of the source in this case), and the user terminal 90 determines whether there are other terminals of which IPv6 addresses in the network segment 2 overlap based on replies from other terminals to the neighbor solicitation (NS) message. When the acquired packet is a neighbor solicitation (NS) message, the communication guiding unit 25 generates, for the source terminal of the acquired packet, a neighbor advertisement (NA) message for guiding in which the MAC address corresponding to the IPv6 address of the acquired packet to be resolved is that of the network monitoring apparatus 20 (Step S311 or Step S312). Then, the processing proceeds to Step S314.

In Step S312, the guiding packet generating processing performed when it is determined that the acquired packet is a neighbor solicitation (NS) message other than the duplicate address detection, a neighbor advertisement (NA) message, or a unicast packet that is not an NDP message is executed. When it is determined that the acquired packet is a neighbor solicitation (NS) message other than the duplicate address detection, a neighbor advertisement (NA) message, or a unicast packet that is not an NDP message, the communication guiding unit 25 generates, for the source terminal of the packet, a neighbor advertisement (NA) message for guiding for notifying the source terminal of the packet of the MAC address of the network monitoring apparatus 20 as the destination MAC address of the terminal, and generates, for the destination terminal of the packet, a neighbor advertisement (NA) message for guiding for notifying the destination terminal of the packet of the MAC address of the network monitoring apparatus 20 as the MAC address of the source terminal. Specifically, the communication guiding unit 25 generates a neighbor advertisement (NA) message in which the MAC address of the network monitoring apparatus 20 itself, the router flag (R flag), the reachable flag (S flag), and the overwrite flag (O flag) are set. Then, the processing proceeds to Step S314.

In Step S313, the guiding packet generating processing performed when it is determined that the acquired packet is a multicast packet other than a predetermined NDP message is executed. When the acquired packet is neither of the router solicitation (RS), the router advertisement (RA), the neighbor solicitation (NS), nor the neighbor advertisement (NA) of the NDP, and the destination address is designated to be a multicast address, the communication guiding unit 25 generates, for each terminal receiving the acquired packet, a neighbor advertisement (NA) message for guiding for notifying the terminal of the MAC address of the network monitoring apparatus 20 as the MAC address corresponding to the source IPv6 address. The communication guiding unit 25 generates, for the source terminal of the packet, a neighbor advertisement (NA) message for guiding for notifying the source terminal of the packet of the MAC address of the network monitoring apparatus 20 as the MAC address of the terminal included in the destination multicast address. Then, the processing proceeds to Step S314.

In Step S314 and Step S315, the guiding information is recorded and the guiding packet is sent. When the guiding packet is generated, the management unit 22 records, as the guiding information, the type of the sent guiding packet (the neighbor advertisement (NA) message/the router advertisement (RA) message) and the correct MAC address, which is not the false MAC address notified in the communication guiding, in the terminal information table in association with the terminal information of each notified terminal (Step S314). The communication guiding unit 25 sends the generated packet via the communication unit 15. Then, the processing illustrated in this flowchart ends.

FIG. 7 is a flowchart illustrating a flow of the transfer packet generating processing according to this embodiment. This flowchart illustrates the transfer packet generating processing of Step S208 in FIG. 5 in more detail.

First, the communication transfer unit 27 determines whether the source MAC address and the source IPv6 address of the acquired packet need to be changed to those of the network monitoring apparatus 20 itself (Step S401). For example, when the acquired packet is communicated between network segments that are different over the router 10, it is determined that the source MAC address needs to be changed. For example, when the acquired packet is a packet on which network address translation is performed, it is determined that the source IPv6 address needs to be changed. When it is determined that the source address needs to be changed, the communication transfer unit 27 changes the source MAC address and the source IPv6 address of the acquired packet to those of the network monitoring apparatus 20 itself (Step S402). When it is determined that the source address does not need to be changed, the processing of Step S402 is skipped.

Then, the communication transfer unit 27 reads the correct MAC address of the terminal corresponding to the destination IPv6 address from the terminal information table, and sets the correct MAC address as the destination MAC address of the transfer packet, to thereby generate the transfer packet (Step S403). When the transfer packet is generated, the communication transfer unit 27 transmits the generated transfer packet to the network via the communication unit 15 (Step S404). Then, the processing illustrated in this flowchart ends.

FIG. 8 is a flowchart illustrating a flow of the restore packet generating processing according to this embodiment. This flowchart illustrates the restore packet generating processing of Step S107 in FIG. 4 in more detail.

First, the guiding release unit 28 reads the guiding information related to one or a plurality of terminals of which guiding is to be released from the terminal information table (Step S501). As described above, the guiding information is the type of the sent guiding packet (the neighbor advertisement (NA) message/the router advertisement (RA) message) and the correct MAC address recorded in association with the terminal information of each notified terminal. When the associated guiding information is read, the guiding release unit 28 generates a restore packet for each of one or a plurality of terminals of which guiding is to be released (Step S502 to Step S504).

Specifically, the guiding release unit 28 refers to the guiding information acquired in Step S501 to determine whether the communication of the terminal that is the destination of the restore packet is guided by the neighbor advertisement (NA) message or by the router advertisement (RA) message (Step S502).

When it is determined that the communication of the terminal that is the destination of the restore packet (hereinafter referred to as an “guiding release target terminal”) is guided by the neighbor advertisement (NA) message (YES in Step S502), the guiding release unit 28 reads the combination of the correct IPv6 address and the correct MAC address corresponding to the false MAC address notified in association with the terminal of which terminal status is changed to “normal” in Step S104 from the guiding information, to thereby generate a unicast neighbor advertisement (NA) message for notifying the guiding release target terminal of the combination (Step S503).

When it is determined that the communication of the guiding release target terminal is guided by the router advertisement (RA) message (NO in Step S502), the guiding release unit 28 reads the combination of the correct IPv6 address and the correct MAC address corresponding to the false MAC address notified in association with the terminal of which terminal status is changed to “normal” in Step S104 from the guiding information, to thereby generate a unicast router advertisement (RA) message for notifying the guiding release target terminal of the combination (Step S504).

The processing in Step S502 to Step S504 is repeatedly executed until the restore packets for all the guiding release target terminals are generated (Step S505). When the restore packets for all the guiding release target terminals are generated, the guiding release unit 28 transmits the generated restore packets to the network via the communication unit 15 (Step S506). Then, the processing illustrated in this flowchart ends.

<Variation>

In the embodiment described above, an example is described in which the network monitoring apparatus 20 acquires packets, frames, and the like sent and received by the user terminals 90 from a monitoring port of a switch, a router, or a gateway (the router 10 in the example in FIG. 1) and operates in a passive mode in which the acquired packets are not transferred (see FIG. 1). However, the network configuration described in the embodiment described above is an example for embodying the technology according to this disclosure and other network configurations may be employed for the embodiment.

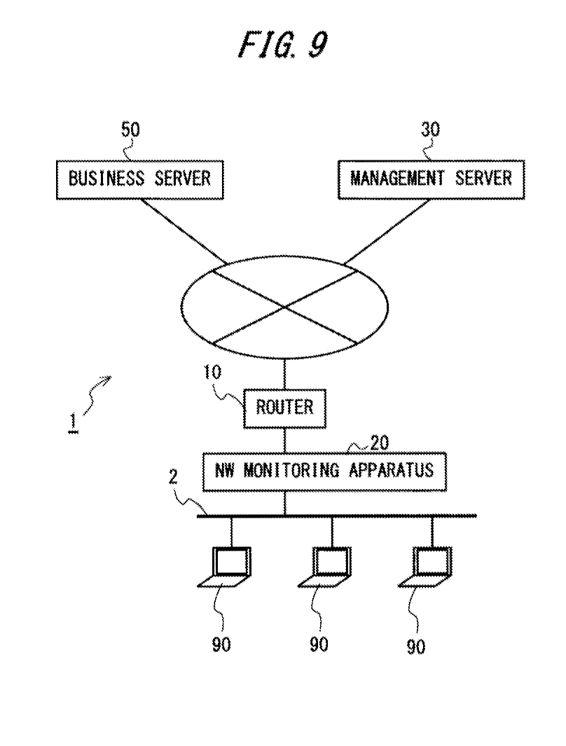

FIG. 9 is a schematic diagram illustrating a variation of a system configuration according to this disclosure. When the configuration illustrated in FIG. 9 is employed, the network monitoring apparatus 20 acquires the packets, the frames, and the like sent and received by the user terminals 90 by being connected between the user terminals 90 in the network and the switch, the proxy, the gateway, the router, or the like. In this case, the network monitoring apparatus 20 operates in an inline mode in which the packets that do not need to be interrupted are transferred.

For example, even when the network monitoring apparatus 20 is not connected to the monitoring port and only connected to the network segment 2 (not shown), by acquiring all the frames flowing in the network segment 2 including frames not addressed to the MAC address of the network monitoring apparatus 20, the network monitoring apparatus 20 can acquire the packets, the frame, and the like sent and received by the user terminals 90. Also in this case, the network monitoring apparatus 20 operates in passive mode. For example, the network monitoring apparatus 20 may be included in the router or the switch.

<Effect>

According to this embodiment, with use of the NDP of the ICMPv6, by controlling the information of the data link layer used in communication, the data communication performed by the terminal in the network of the IPv6 environment can be guided to any terminal. According to this embodiment, the communication can be interrupted by cancelling the transfer of the guided communication data, and the communication data can be transferred to any destination.

According to this embodiment, for example, if an unauthorized access terminal, a malware infected terminal, or the like is detected when all IPv6 communication in the IPv6 environment or the dual stack environment is monitored, the communication of the corresponding terminal can be guided to the network monitoring apparatus 20 with use of the neighbor advertisement (NA) message and the router advertisement (RA) message. As a result, the security level can be enhanced without changing the configuration of the network and the like.

What is claimed is:

1. An information processing apparatus, comprising:
a communication data acquisition unit acquires communication data in a network;
a target terminal determination unit determines whether a terminal included in a source or a destination of the acquired communication data is a target terminal meeting a predetermined condition; and
a communication guiding unit, by notifying the target terminal of a physical address of a predetermined terminal as a physical address of a terminal other than the target terminal, guides communication data sent from the target terminal, to the predetermined terminal.

2. The information processing apparatus according to claim 1, wherein the communication guiding unit further notifies the terminal other than the target terminal of the physical address of the predetermined terminal as the physical address of the target terminal, to guide communication data sent to the target terminal as a destination, to the predetermined terminal.

3. The information processing apparatus according to claim 2, further comprising a type determination unit determines a type of the communication data,
wherein when the type determination unit determines that the communication data is a type of communication data for multicasting a physical address of a source terminal of the communication data, the communication guiding unit notifies one or a plurality of terminals included in a destination of the communication data of the physical address of the predetermined terminal as a physical address of the source terminal.

4. The information processing apparatus according to claim 3, wherein when the type determination unit determines that the communication data is a type of communication data for multicasting a physical address of a router, the communication guiding unit notifies one or a plurality of terminals included in a destination of the multicast of the physical address of the predetermined terminal as the physical address of the router.

5. The information processing apparatus according to claim 2, further comprising a type determination unit for determining a type of the communication data,
wherein when the type determination unit determines that the communication data is a type of communication data for unicasting a physical address of a source terminal of the communication data, the communication guiding unit notifies the source terminal of the physical address of the predetermined terminal as a physical address of a destination terminal, and notifies the destination terminal of the physical address of the predetermined terminal as the physical address of the source terminal.

6. The information processing apparatus according to claim 5, wherein when the type determination, unit determines that the communication data is a type of communication data for unicasting a physical address of a router, the communication guiding unit notifies the router of the physical address of the predetermined terminal as a physical address of a destination terminal, and notifies the destination terminal of the physical address of the predetermined terminal as the physical address of the router.

7. The information processing apparatus according to claim 2, further comprising a type determination unit determines a type of the communication data,
wherein when the type determination unit determines that the communication data is a type of communication data for inquiring a physical address of a terminal in the network and that a destination logical address and a source logical address set in the communication data are identical, the communication guiding unit notifies each of one or a plurality of terminals that receive the communication data of the physical address of the predetermined terminal as a physical address of a source terminal.

8. The information processing apparatus according to claim 2, further comprising a type determination unit determines a type of the communication data,
wherein when the type determination unit determines that the communication data is a type of communication data for inquiring a physical address of a terminal in the network, the communication guiding unit notifies a source terminal of the communication data of the physical address of the predetermined terminal as a physical address of a destination terminal, and notifies each of one or a plurality of destination terminals of the communication data of the physical address of the predetermined terminal as a physical address of the source terminal.

9. The information processing apparatus according to claim 2, further comprising a type determination unit determines a type of the communication data,
wherein when the type determination unit determines that the communication data is a type of communication data for providing notification of a physical address of a terminal in the network, the communication guiding unit notifies a source terminal of the communication data of the physical address of the predetermined terminal as a physical address of a destination terminal, and notifies each of one or a plurality of destination terminals of the communication data of the physical address of the predetermined terminal as a physical address of the source terminal.

10. The information processing apparatus according to claim 1, wherein the communication guiding unit provides notification of a physical address of the information processing apparatus as the physical address of the predetermined terminal, to guide communication data to the information processing apparatus.

11. The information processing apparatus according to claim 10, further comprising a communication interruption unit interrupts at least a part of communication with the target terminal by not transferring, to a proper destination, at least a part of communication data acquired by the information processing apparatus as a result of guiding by the communication guiding unit.

12. The information processing apparatus according to claim 10, further comprising a communication transfer unit transfers the communication data to a predetermined destination when the type determination unit determines that the communication data sent from the target terminal and acquired by the information processing apparatus as a result of guiding by the communication guiding unit is a type of communication data that can be transferred to the predetermined destination.

13. The information processing apparatus according to claim 1, further comprising a guiding release unit, when a terminal once determined by the target terminal determination means to be the target terminal does not meet the predetermined condition anymore, releases guiding of communication by the communication guiding unit by notifying the terminal other than the target terminal of a physical address of the target terminal, and notifying the target terminal of the physical address of the terminal other than the target terminal.

14. The information processing apparatus according to claim 1, further comprising a management unit manages terminal information of a terminal in the network,
wherein the target terminal determination unit determines whether a terminal included in the source or the destination of the communication data is a target terminal meeting a predetermined condition by comparing the source or the destination of the communication data and terminal information managed by the management unit as a target of communication guiding.

15. A method for causing a computer to execute:
acquiring communication data in a network;
determining whether a terminal included in a source or a destination of the acquired communication data is a target terminal meeting a predetermined condition; and
notifying the target terminal of a physical address of a predetermined terminal as a physical address of a terminal other than the target terminal to guide communication data sent from the target terminal, to the predetermined terminal.

16. An computer-readable non-transitory medium on which is recorded a program for causing a computer to execute:
acquiring communication data in a network;
determining whether a terminal included in a source or a destination of the acquired communication data is a target terminal meeting a predetermined condition; and
notifying the target terminal of a physical address of a predetermined terminal as a physical address of a terminal other than the target terminal to guide communication data sent from the target terminal, to the predetermined terminal.
